(19) United States
(12) Patent Application Publication
(10) Pub. No.: US 2023/0298007 A1
(43) Pub. Date: Sep. 21, 2023

(54) ENHANCED DUE DILIGENCE SYSTEM FOR CRYPTOCURRENCIES

(71) Applicant: Vishal GUPTA, New Delhi (IN)

(72) Inventor: Vishal GUPTA, New Delhi (IN)

(21) Appl. No.: 18/018,815

(22) PCT Filed: Jul. 29, 2021
(86) PCT No.: PCT/IN2021/050737

§ 371 Date: Jan. 30, 2023

(30) Foreign Application Priority Data
Jul. 29, 2020 (IN) 202011032577

(51) Int. Cl. G06Q 20/36; G06Q 20/38; G06Q 20/40; G06Q 20/02; G06Q 20/10

(52) U.S. Cl. CPC G06Q 20/3674; G06Q 20/02; G06Q 20/10; G06Q 20/3678; G06Q 20/3821; G06Q 20/389; G06Q 20/40145; G06Q 20/4016

(57) ABSTRACT

A digital wallet verification system in a blockchain ecosystem providing enhanced due diligence for cryptocurrency. The system includes receiving a first profile and a digital wallet. The system determines a status for the first profile, based on a verification information. Further, a score for the digital wallet is calculated based on the status of a second profile performing a blockchain transaction in the digital wallet associated with the first profile. The system provides certain private KYC information of the second profile to the first profile and indicating the status of the first profile, the second profile and/or the score associated with any digital wallet publicly on the internet at large.

### FIELD OF THE INVENTION

The present disclosure relates to blockchain and cryptocurrency transaction and more particularly, to a system and a method for digital wallet verification.

### BACKGROUND

A cryptocurrency is a medium of exchange for securely exchanging information over a computerized network, which is a process made possible by certain principles of cryptography. Cryptocurrencies are specifications regarding the use of currency which seek to incorporate principles of cryptography to implement a distributed, decentralized, and secure information economy.

Cryptocurrency transactions are transferred between peers and are recorded on a public digital ledger called a blockchain, and every process along the way is secured by cryptography. It is decentralized, i.e., it is controlled by users and computer algorithms and not a central government. It is distributed, such that the blockchain is hosted on many computers across the globe. The blockchain acts like a decentralized bank ledger keeping a record of transactions and balances. When a blockchain transaction is made, that blockchain transaction is sent out to all users hosting a copy of the blockchain.

The blockchain transactions such as the cryptocurrency transactions are sent between peers using a digital wallet. The digital wallet uses algorithms and software to transfer balances from one account (AKA a public address) to another.

To transfer funds, knowledge of a password (aka a private key) associated with the account is needed. Transactions made between peers are encrypted and then broadcast to the cryptocurrency’s network and queued up to be added to the public ledger. Blockchain transactions are then recorded on the public ledger.

The blockchain transactions may definition pseudo-anonymous. This means that fundamentally two users can engage in blockchain transactions with each other without revealing the identity of either of them. Instead, the transaction is cryptographically signed to ensure that the transaction took place, and there is a public record of such transaction that can be verified by all profiles in the blockchain environment.

Now, as it is understood, the blockchain transactions have an identity problem. The anonymous nature of profiles and their associated wallets makes it difficult to regulate it. A Know-Your-Customer (KYC) or a Customer Due-Diligence (CDD) capturing information about a user, cannot be executed efficiently given the non-face-to-face operations of the profiles. Hence, there is no solution proposed to authenticate the profiles, their associated wallets or the users operating these profiles and performing the blockchain transactions from the associated digital wallets. Furthermore, the banking industry face difficulty in conducting Enhanced due Diligence (EDD) on the digital wallets as the user may keep changing or opening new profiles and associating digital wallets. The financial institutions regulating such blockchain transactions face unlimited liability for any lapses in operating the blockchain transactions.

The countries such as United States and other countries’ governmental bodies regulating the blockchain transaction are required by law to capture information about the users, usually encompassed within the KYC process. Furthermore organizations/individuals that enable the blockchain transaction are also required to monitor the blockchain transaction for potential money laundering activity. Problems arising out of this new cryptocurrency technology operating over a global computer network include challenges of auditing the blockchain transaction into one another digital wallet. The unidentified blockchain transactions may lead to facing the risk of blacklisting.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

In an embodiment of the present invention, a digital wallet verification system is operatively coupled to a blockchain ecosystem providing enhanced due diligence for cryptocurrency. The system includes a receiving module configured to receive a first profile and at least one digital wallet from at least one blockchain, associated with the first profile; and receive at least one of a mobile number, an email address, a biometric information, an authentication information, and a third-party user ID, from the first profile. The system includes a verification module in communication with the receiving module and configured to determine a status for the first profile, based on a verification information. The system includes a scoring module in communication with the receiving module configured to calculate a score for the digital wallet associated with the first profile. The score is calculated based on the status of a second profile performing a blockchain transaction in the digital wallet associated with the first profile. The system further includes a Customer Due Diligence (CDD) module in communication with the receiving module and the verification module configured to provide certain private KYC information of the second profile to the first profile, upon receiving a blockchain transaction from the second profile in the digital wallet associated with the first profile. The system includes an information module in communication with the receiving module and the verification module configured to indicate the status of the first profile, the second profile and/or the score associated with any digital wallet publicly on the internet at large.

In another embodiment of the present invention, a method for digital wallet verification in a blockchain ecosystem providing enhanced due diligence for cryptocurrency. The method includes receiving, a first profile and at least one digital wallet from at least one blockchain, associated with the first profile. The method includes receiving, at least one of mobile number, email address, biometric information, authentication information, third party user ID, and alike from the first profile. The method further includes determining, a status for the first profile, based on a verification information. The method includes calculating, a score for the digital wallet associated with the first profile. The score is calculated based on the status of second profile performing a blockchain transaction in the digital wallet associated with the first profile. The method includes providing, certain private KYC information of the second profile to the first profile, upon receiving the blockchain transaction from the second profile in the digital wallet associated with the first profile. The method includes indicating, the status of profile and/or the score associated with any digital wallet publicly on the internet at large.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram depicting an environment of implementation of a digital wallet verification system, according to an embodiment of the present disclosure;

FIG. 2 illustrates a block diagram of the digital wallet verification system, according to an embodiment of the present disclosure; and

FIG. 3 illustrates a flowchart depicting a method for digital wallet verification, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the present disclosure in any way.

For example, any terms used herein such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more...” or “one or more element is required.”

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Embodiments of the present invention will be described below in detail with reference to the accompanying drawings.

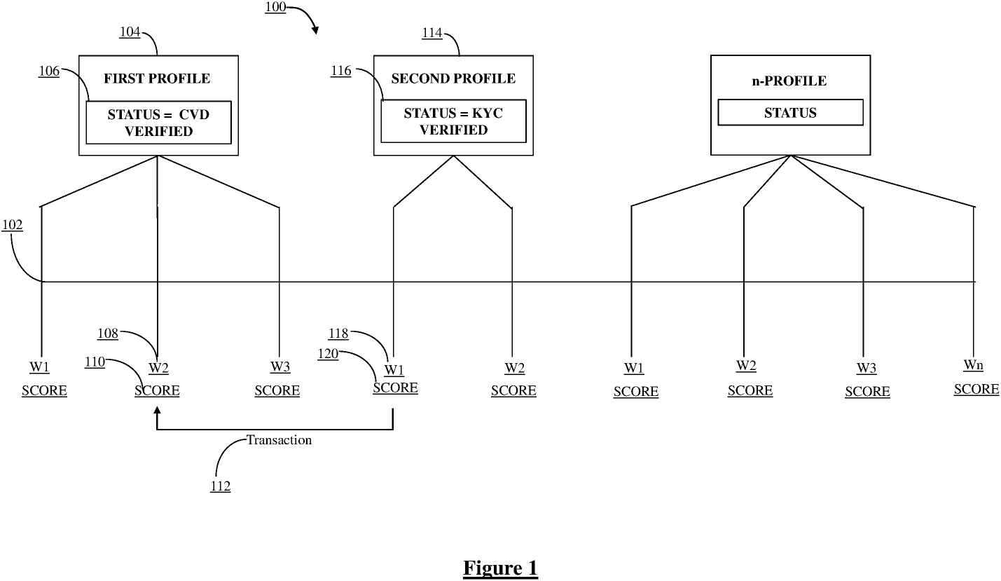

FIG. 1 illustrates a block diagram depicting an environment 100 of implementation of a digital wallet verification system, according to an embodiment of the present disclosure.

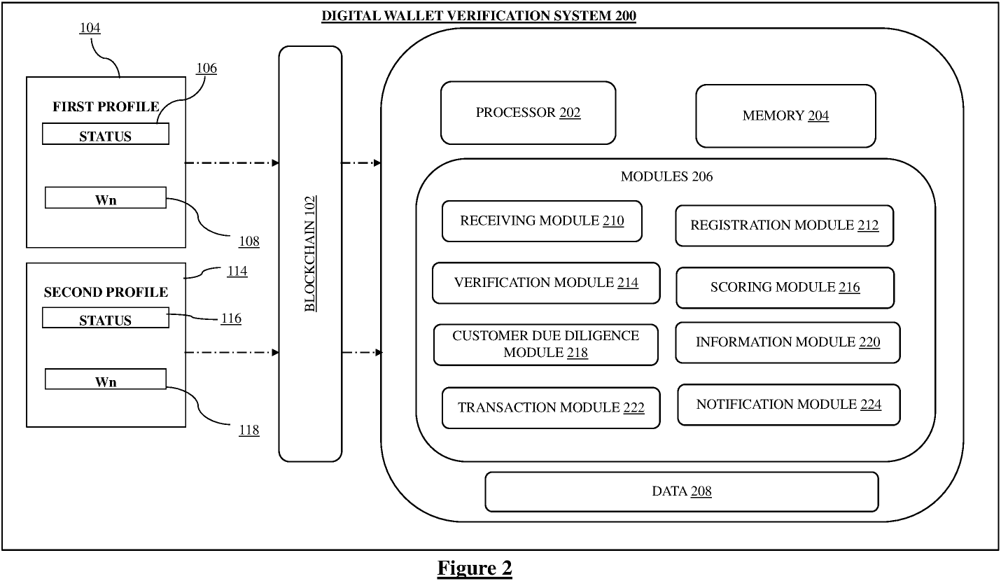

FIG. 2 illustrates a block diagram of the for digital wallet verification system 200, according to an embodiment of the present disclosure.

Referring to FIG. 1 and FIG. 2, the digital wallet verification system 200 may be implemented as being operatively coupled to a blockchain ecosystem 102 for providing enhanced due diligence for cryptocurrency.

The digital wallet verification system 200 may include a user device (now shown) for providing a user input through an application. The digital wallet verification system may include the application adapted to be installed in the user device or operated as Software as a service (SAAS) from the user device of the user. The user device may include, but is not limited to, a tablet PC, a Personal Digital Assistant (PDA), a mobile-device, a palmtop computer, a laptop computer, a desktop computer, a server, a cloud server, a remote server, a communications device, a wireless-telephone, or any other machine controllable through the wireless or wired network and capable of executing a set of instructions (sequential or otherwise) that specify actions to be taken by that machine.

The network may include wired networks, wireless networks, Ethernet AVB networks, or combinations thereof. The wireless network may be a cellular telephone network, an 802.11, 802.16, 802.20, 802.1Q, or WiMax network. Further, the network may be a public network, such as the Internet, a private network, such as an intranet, or combinations thereof, and may utilize a variety of networking protocols now available or later developed including, but not limited to TCP/IP based networking protocols.

The user provides the input through the application, a first profile 104 and a digital wallet 108 from the blockchain 102. The digital wallet 108 is thus associated with the first profile 104.

In an example embodiment, the first profile 104 may associate plurality of digital wallets 108 (W1, W2, W3,...).

Similarly, in a non-limiting context, another user provides the user input through the application as a second profile 114 and a digital wallet 118 from the blockchain 102. The digital wallet 118 is thus associated with the second profile 114.

In an example embodiment, the second profile 114 may associate plurality of digital wallets 118 (W1, W2,...).

In an embodiment, n-users may provide the user input through the application for creating n-profiles and may associate n-digital wallets with corresponding profiles from the blockchain 102.

In an example embodiment, the first profile 104 may have a status 106. The status 106 may indicate successful submission of a verification information by the first profile 104.

In an example embodiment, the second profile 114 may have a status 116. The status 116 may indicate successful submission of the verification information by the second profile 114.

Similarly, in a non-limiting context and for the brevity, the digital verification system may have n-profile may with the corresponding status indicating the submission of the verification information by the n-profile.

In an example embodiment, the digital wallet 108, 118 may allow the profiles to store, manage and perform transaction of their cryptocurrency over the blockchain 102. In the example, the digital wallet 108, 118 may contain cryptocurrencies. The digital wallet 108, 118 may include an identification key which may be a public key on any public or private or hybrid blockchain. The public key allows to view the profile and its information associated with the digital wallet. Each of the digital wallet (W1, W2, W3) 108, 118 may have a unique public key associated with them. In an example, with the help of the public key of the digital wallet (W1) 108, first profile 104 information and a status 106 may be viewed.

In an example embodiment, the digital wallet (W1) 118 associated with the second profile 114 may perform the blockchain transaction 112 to the digital wallet (W2) 108 associated with the first profile 104.

In an example embodiment, a score 110 is calculated for the digital wallet (W2) 108 associated with the first profile 104 upon receiving the blockchain transaction 112 the digital wallet (W1) 118 associated with the second profile 114.

FIG. 2 illustrates a block diagram of the digital wallet verification system 200, according to an embodiment of the present disclosure. The digital wallet verification system 200 may include, but is not limited to, a processor 202, a memory 204, modules 206, and a data 208. The modules 206 and the memory 204 may be coupled to the processor 202.

The processor 202 can be a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is adapted to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulate signals based on operational instructions.

Further, the modules 206 can be implemented in hardware, instructions executed by a processing unit, or by a combination thereof. The processing unit can comprise a computer, a processor, such as the processor 202, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 206 may be machine-readable instructions, applications (software) which, when executed by a processor/processing unit, perform any of the described functionalities.

In an embodiment, the modules 206 may include a receiving module 210, a registration module 212 a verification module 214, a scoring module 216, a customer due diligence (CDD) module 218, an information module 220, a transaction module 222 and a notification module 224 may be in communication with each other. The data 208 serves, amongst other things, as a repository for storing data processed, received, and generated by one or more of the modules 206.

Referring to FIG. 1 and FIG. 2, the receiving module 210 may be configured to receive the first profile 104 and the digital wallet 108 from the blockchain 102. The receiving module 210 may be configured to receiving at least one of mobile number, email address, biometric information, authentication information, third party user ID, and alike from the first profile 104. Such information is provided by the first user operating the first profile 104.

In an example embodiment, the receiving module 210 may be configured for receiving the second profile 114 and the digital wallet 118 from the blockchain 102.

Similarly, in an example embodiment, the receiving module 210 may be configured for receiving n-profiles and the associated digital wallets.

The receiving module 210 is in communication with the registration module 212. The registration module 212 is configured to determine an ownership for the digital wallet 108 associated with the first profile 104. In an example embodiment, the registration module 212 determines that the first profile 104 is the legal owner of the digital wallet 108 by requesting the first profile 104 to process the blockchain transaction. In an example, the blockchain transaction is having a cryptocurrency amount transferred from the digital wallet 108 associated with the first profile. In case, the first profile 104 has associated more than one digital wallet (W1, W2, W3,....Wn) 108, then the registration module 212 may determine the ownership for each of the digital wallet (W1, W2, W3,....Wn) 108 associated with the first profile 104. In an example embodiment, the registration module 212 may determine the ownership for the digital wallet 108 if the first profile 104 submits a cryptographically verifiable document (CVD) or a verifiable credentials. The submission of CVD may be indicative of verifying the ownership of the digital wallet 108 by the first profile 104.

The receiving module 210 is in communication with the verification module 212. The verification module 212 is configured to determine the status 106 for the first profile 104, based on the verification information. The verification information may be including of the CVD. In an example embodiment, the verification information may be including of a Know-Your-Customer (KYC) information, biometric information, MSISDN, social media handle, email or other GUID.

In an embodiment, the verification module 212 determines the status 106 for the first profile 104. The status 106 indicates the verification information submitted by the first profile 104. In an example, the status 106 of the first profile 104 may be understood as an indicator to determine the level of acceptance of the verification information submitted. The verification information belonging to the high-level of acceptance may be the CVD. The verification information belonging to the low-level of acceptance may be the know-your-customer (KYC) information, biometric information, MSISDN, social media handle, email or other GUID.

In an example, the status 106 of the first profile 104 may be represented in form of colours to signify the level of verification information provided by the first profile 104. In the example, the submission of CVD may be considered as the high-level status and may achieve a green colour status. The submission of verification information such as know-your-customer (KYC) information, biometric information, MSISDN, social media handle, email or other GUID may be considered as low-level status and may achieved a yellow colour status. The absence of submission of verification information may result in a null value for status and may be considered as the lowest level of status with a red colour status. In an example, the submission of the verification information by the first profile 104 assists the digital verification system 200 ascertain the authenticity of the said profile. In an example embodiment, the first profile 104 or the second profile 114 may update the status 106, 116 to achieve the high-level. In an example, if the second profile 114 has submitted the know-your-customer (KYC) information, biometric information, MSISDN, then the status 116 of the second profile 114 may be the low-level but if the second profile 114 submits the CVD, the status 116 may be updated to high-level.

In an example embodiment, the digital wallet verification system 200 may always prefer that the profile’s update the status to the high-level.

In an embodiment, the scoring module 216 is in communication with the receiving module 210, the registration module 212 and the verification module 214. The scoring module 216 is configured to calculate the score 110 for the digital wallet. In an example, the score 110 is calculated for the digital wallet (W1, W2, W3) 108 associated with the first profile 104.

In an example embodiment, the digital wallet (W1) 118 associated with the second profile 114 may perform the blockchain transaction 112. The score 110 is calculated for the digital wallet (W2) 108 associated with the first profile 104 upon receiving the blockchain transaction 112. The score 110 may include, but is not limited to, an integer value, a grade, a rating. The score 110 is calculated considering the status 116 of second profile 114 performing the blockchain transaction 112 in the digital wallet (W2) 108 associated with the first profile 104. In an example, the high-level of status achieved by the second profile 114 may improve the score 110 of the digital wallet (W2) 108. Whereas the low-level of status achieved by the second profile 114 may reduce the score 110 of the digital wallet (W2) 108.

In an example embodiment, the scoring module is further configured take into consideration the following factor but not limiting to including, risk of country, risk of amounts, risk, and other risk as per guidelines of regulators for calculating the score. Such mentioned factors improve or reduce the score 110.

In an embodiment, the Customer Due Diligence (CDD) module 218 is in communication with the receiving module 210, the registration module 212, the verification module 214 and the scoring module 216. The CDD module 218 is configured to provide certain private KYC information of the second profile 114 to the first profile 104, upon receiving the blockchain transaction 112 from the second profile 114 in the digital wallet 108 associated with the first profile 104. In an example, as the second profile 114 has performed the blockchain transaction 112 with the first profile 104, therefore the first profile 104 may be able to view the private KYC information as submitted by the second profile 114. Thus, the first profile 104 may be able to verify the identity of the second profile 114 performing the transaction.

In an example embodiment, in case, the digital wallet 108 associated with the first profile 104 may perform the blockchain transaction 112 with the digital wallet 118 associated with the second profile 114, then, the second profile 114 may be able to view the certain private KYC information of the first profile 104.

In an embodiment, the information module 220 is in communication with the receiving module 210, the registration module 212, the verification module 214, the scoring module 216, and the CDD module 218. The information module is configured to use the public key associated with the digital wallet 108, 118 on any public blockchain to view the profile and its public information. In an example, the public information may include the status 106 of the first profile 104 and/or the score 106 associated with any of the digital wallet 108 publicly on the internet at large.

In an embodiment, the transaction module 222 is in communication with the receiving module 210, the registration module 212, the verification module 214, the scoring module 216, the CDD module 218 and the information module 220. The transaction module 222 is adapted to ensure exchange of a public and a private transaction information between the first profile 104 and the second profile 114. In an example, the private transaction information may include at least one of, tax information, invoice, transaction amount provided by the second profile 114. In an example, the public transaction information may include at least one of, jurisdiction, tax amount, transaction status, tax jurisdiction. In an example, the private transaction information may only be available when the blockchain transaction 112 is performed. In an example, both the first profile 104 and the second profile 114 may provide input for the private transaction information and the private transaction information.

In an embodiment, the notification module 224, is in communication with the receiving module 210, the registration module 212, the verification module 214, the scoring module 216, the CDD module 218, the information module 220 and the transaction module 222. The notification module 224 is configured to provide a notification to the first profile 104. In an example, the notification may include an information of the second profile 114, the status 116 of the second profile 114. In an example, the notification module 224 is further adapted to receive a contact information of the second profile 114 from the first profile 106 and transmit a message to the second profile 114 using the contact information for updating the status 116 and/or associate a plurality of digital wallets to the second profile 114. In an example, when the digital wallet 118 associated with the second profile 114 performs the blockchain transaction 112 with the digital wallet 108 associated with the first profile 104 then the first profile 104 may provide the contact information including email, mobile number related to the second profile 114. The digital verification system 200 determines the status 116 of the second profile 114. In the example, if the status 116 of the second profile 114 has not achieved a high-level then the contact information may be used to transmit the message for updating the status 116. The message may be in form of an email, a SMS, or communication alike transmitted to the second profile 114 informing to submit the verification information and update the status 116.

In another example, the notification module 224 may be configured to provide the notification to the second profile 114 including the certain public information of the first profile 104, the status 106 of the first profile. Thus, the second profile 114 may view the certain public information of the first profile 104, the status 106 of the first profile. In an example, the public information may include but not limited to name of the first profile 104, photo of the first profile 104 and any other information defined by the first profile to be publicly available. In this example, the second profile 114 receives said notification before performing the blockchain transaction 112. Further, the notification module 224 may be further configured to receive the contact information of the first profile 104 from the second profile 114 and transmit the message to the first profile 104 using the contact information for updating the status 106.

In an embodiment, the notification module 224 may be further configured to transmit a message to an external agency or institution after a predetermined criteria if the status 106, 116 is not updated. In an example, upon transmitting the message to the first profile 104 or the second profile 114 for updating the status 106, 116, if the first profile 104 or the second profile 114 fails to update the status 106, 116 then, the message is transmitted to the external agency or institution. The message may include informing the external agency or institution that the first profile 104 or the second profile 114 has failed to update the respective status 106, 116 thus indicating a possibility of a fraudulent transaction, money laundering activity, suspicious activity. The external agency or institution may include, federal, government, financial institutions responsible for regulating the rules, processes and laws related to fair and legal transaction on blockchain. The predetermined criteria may be defined in the digital wallet verification system. The predetermined criteria may include, time interval, or any triggering event post which the message is transmitted to the external agency or institution.

In an embodiment, the notification module 224 may be further configured to tagging the digital wallet 108, 118 or the respective status 106, 116 of the first profile 104 and the second profile 114 as potentially associated with a blacklisted transaction. The blacklisted transaction may be defined by the external agency or the institution indicating that the transaction is a suspicious activity with some criminal antecedents. The tagging of the digital wallet 108, 118 or the respective status 106, 116 associated with the blacklisted transaction is based onat least one of:
(a) determining the digital wallet processing the blockchain transaction 102 in the cluster of related transactions is contained on a public or private blacklist;
(b) determining the profile associated with digital wallet processing the blockchain transaction 112 in the cluster of related transactions is associated with a sanctions list or sanctioned country
(c) determining the profile associated with digital wallet processing the blockchain transaction 112 in the cluster of related transactions is associated with a transaction amount over a predetermined threshold and the status of the profile is not updated after the predetermined criteria.

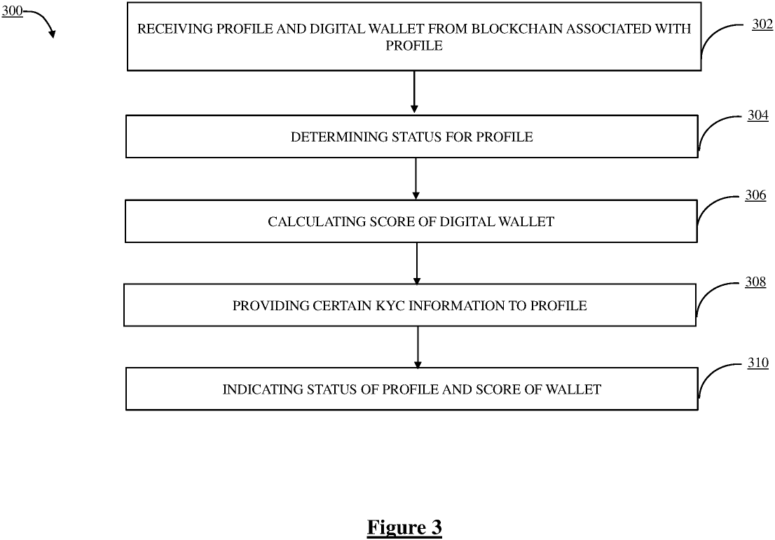

FIG. 3 illustrates a flow chart depicting a method 300 for digital wallet verification in a blockchain ecosystem providing enhanced due diligence for cryptocurrency, according to an embodiment of the present disclosure. The method 300 may be a computer-implemented method executed. For the sake of brevity, constructional and operational features of the digital wallet verification 200 that are already explained in the description of FIG. 1 and FIG. 2, are not explained in detail in the description of FIG. 3.

At step 302, the method 300 includes receiving a first profile and at least one digital wallet from at least one blockchain, associated with the first profile. Further, the method includes receiving, at least one of a mobile number, an email address, a biometric information, an authentication information, a third party user ID, and alike from the first profile.

At step 304, the method 300 includes determining a status for the first profile, based on a verification information.

At step 306, the method 300 includes calculating a score for the digital wallet associated with the first profile. In an embodiment, the score is calculated based on the status of second profile performing a blockchain transaction in the digital wallet associated with the first profile.

At step 308, the method 300 includes providing certain private KYC information of the second profile to the first profile, upon receiving the blockchain transaction from the second profile in the digital wallet associated with the first profile.

At step 310, the method 300 includes indicating the status of profile and/or the score associated with any digital wallet publicly on the internet at large.

The present offers at least the below advantages:
a) The present invention provides a strong authentication means to determine the ownership of the wallet with the profile.
b) The present invention discloses embodiments to determine status of the profile and its associated wallets based on the verification information submitted by the profile. The type of the verification information submitted by the profile determines the level of status achieved.
c) The present invention discloses embodiments to view the status of the profile before performing the blockchain transaction.
d) The present invention provides the profile to provide contact information for transmitting the message for updating the status of the profile.
e) The present invention solves the unsolved long felt need of the prior arts by disclosing the system and the method to perform enhanced due diligence in the blockchain cryptocurrency transaction.
f) The present invention flags the suspicious blockchain transactions or the suspicious profiles with low-level of status to the agency or institutions thus preventing frauds, scams, money-laundering activities.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A digital wallet verification system (200) operatively coupled to a blockchain ecosystem providing enhanced due diligence for cryptocurrency, the system comprising:
a receiving module configured to:
receive a first profile and at least one digital wallet from at least one blockchain, associated with the first profile; and receive at least one of a mobile number, an email address, a biometric information, an authentication information, and a third-party user ID, from the first profile;
a verification module in communication with the receiving module and configured to determine a status for the first profile, based on a verification information;
a scoring module in communication with the receiving module configured to calculate a score for the digital wallet associated with the first profile;
wherein the score is calculated based on the status of a second profile performing a blockchain transaction in the digital wallet associated with the first profile;
a Customer Due Diligence (CDD) module in communication with the receiving module and the verification module configured to provide certain private KYC information of the second profile to the first profile, upon receiving a blockchain transaction from the second profile in the digital wallet associated with the first profile; and
an information module in communication with the receiving module and the verification module configured to indicate the status of the first profile, the second profile and/or the score associated with any digital wallet publicly on the internet at large.

2. The system as claimed in claim 1, comprising a registration module configured to:
determine ownership for the digital wallet (108) associated with the first profile, wherein the determining comprising:
processing the blockchain transaction, wherein the blockchain transaction is indicative of having a cryptocurrency amount transferred from the digital wallet associated with the first profile; or
submitting a cryptographically verifiable document (CVD) or verifiable credentials, wherein the CVD is indicative of verifying ownership of the digital wallet by the first profile.

3. The system as claimed in claim 1 wherein, the verification module is configured to:
verify the identity of the first profile based on the verification information;
wherein the verification information comprising the CVD; and
updating the status of the first profile, wherein the status indicates successful submission of the CVD by the first profile.

4. The system as claimed in claim 1 wherein, the verification module is configured to:
verify the identity of the first profile based on the verification information, wherein the verification information comprising a Know-Your-Customer (KYC) information, biometric information, MSISDN, social media handle, email or other GUID;
updating the status of the first profile, wherein the status indicates successful submission of know-your-customer facility, a biometric information, an MSISDN, a social media handle, an email or other GUID by the first profile.

5. The system as claimed in claim 1 comprising: a notification module configured to provide a notification to the first profile, wherein, the notification comprising an information of the second profile, the status of the second profile;
receive a contact information of the second profile from the first profile and transmit a message to the second profile using the contact information for updating the status and/or associate a plurality of digital wallets to the second profile.

6. The system as claimed in claim 5, wherein the notification module is configured to:
provide a notification to the second profile, wherein, the second profile views the notification comprising a certain public information of the first profile and the status of the first profile;
receive a contact information of the first profile from the second profile and
transmit a message to the first profile using the contact information for updating the status.

7. The system as claimed in claim 5, wherein the notification module is configured to:
transmit a message to one of an external agency or an institution after a predetermined criteria if the status is not updated.

8. The system as claimed in claim 5, wherein the notification module is configured to:
tagging the digital wallet or the status of profile as potentially associated with blacklisted transaction upon at least one of:
(a) determining that the digital wallet processing the blockchain transaction in the cluster of related transactions is contained on a public or private blacklist;
(b) determining that the profile associated with digital wallet processing the blockchain transaction in the cluster of related transactions is associated with a sanctions list or sanctioned country; and
(c) determining that the profile associated with digital wallet processing the blockchain transaction in the cluster of related transactions is associated with a transaction amount over a predetermined threshold and the status of the profile is not updated after the predetermined criteria.

9. The system as claimed in claim 1, wherein the scoring module is configured to take into consideration risk of country, risk of amounts, risk, and other risk as per guidelines of regulators for calculating the score.

10. The system as claimed in claim 1, comprising of a transaction module configured to:
exchange public and private transaction information between the first profile and the second profile;
wherein the private transaction information comprises at least one of, tax information, invoice, and transaction amount provided by the second profile; and
wherein the public transaction information comprising at least one of, jurisdiction, tax amount, transaction status, tax jurisdiction.

11. The system as claimed in claim 1, wherein the CDD module is configured to provide certain private KYC information of the first profile to the second profile, upon receiving the blockchain transaction from the second profile in the digital wallet associated with the first profile.

12. A method for digital wallet verification in a blockchain ecosystem providing enhanced due diligence for cryptocurrency, the method comprising:
receiving, a first profile and at least one digital wallet from at least one blockchain, associated with the first profile;
receiving, at least one of mobile number, email address, biometric information, authentication information, third party user ID, and alike from the first profile;
determining, a status for the first profile, based on a verification information;
calculating, a score for the digital wallet associated with the first profile;
wherein the score is calculated based on the status of second profile performing a blockchain transaction in the digital wallet associated with the first profile;
providing, certain private KYC information of the second profile to the first profile, upon receiving the blockchain transaction from the second profile in the digital wallet associated with the first profile;
indicating, the status of profile and/or the score associated with any digital wallet publicly on the internet at large.

13. The method as claimed in claim 12, comprising:
determining ownership for the digital wallet associated with the first profile, comprising:
processing the blockchain transaction, wherein the blockchain transaction is indicative of having a cryptocurrency amount transferred from the digital wallet associated with the first profile; or
submitting a cryptographically verifiable document (CVD) or verifiable credentials, wherein the CVD is indicative of verifying ownership of the digital wallet by the first profile.

14. The method as claimed in claim 12 wherein, comprising:
verifying the identity of the first profile based on the verification information;
wherein the verification information comprising of the CVD,
updating the status of the first profile, wherein the status indicates successful submission of the CVD by the first profile.

15. The method as claimed in claim 12 wherein, comprising:
verifying the identity of the first profile based on the verification information;
wherein the verification information comprising of a Know-Your-Customer (KYC) information, biometric information, MSISDN, social media handle, email or other GUID;
updating the status of the first profile, wherein the status indicates successful submission of know-your-customer facility, biometric information, MSISDN, social media handle, email or other GUID by the first profile.

16. The method as claimed in claim 12, comprising:
providing a notification to the first profile, wherein,
the notification comprising of an information of second profile, the status of second profile;
receiving a contact information of the second profile from the first profile and
transmitting a message to the second profile using the contact information for updating the status and/or associate a plurality of digital wallets to the second profile.

17. The method as claimed in claim 16, comprising:
providing a notification to the second profile, wherein,
the second profile views the notification comprising of a certain public information of the first profile, the status of the first profile;
receiving a contact information of the first profile from the second profile and
transmitting a message to the first profile using the contact information for updating the status.

18. The method as claimed in claim 16, wherein the method comprising transmitting a message to an external agency or institution after a predetermined criteria if the status is not updated.

19. The method as claimed in claim 16, wherein the method comprising: tagging the digital wallet or the status of profile as potentially associated with blacklisted transaction upon at least one of:
(a) determining that the digital wallet processing the blockchain transaction in the cluster of related transactions is contained on a public or private blacklist;
(b) determining that the profile associated with digital wallet processing the blockchain transaction in the cluster of related transactions is associated with a sanctions list or sanctioned country; and
(c) determining that the profile associated with digital wallet processing the blockchain transaction in the cluster of related transactions is associated with a transaction amount over a predetermined threshold and the status of the profile is not updated after the predetermined criteria.

20. The method as claimed in claim 12, wherein the calculating the score taking into consideration risk of country, risk of amounts, risk, and other risk as per guidelines of regulators for calculating the score.

21–22. (canceled)
